(19) United States
(12) Patent Application Publication
(10) Pub. No.: US 2014/0268817 A1
(43) Pub. Date: Sep. 18, 2014

(54) DECORATION FOR CANDLE

(71) Applicant: CHIN-SHENG YANG, Tainan City (TW)

(72) Inventor: CHIN-SHENG YANG, Tainan City (TW)

(21) Appl. No.: 13/831,635

(22) Filed: Mar. 15, 2013

(51) Int. Cl. F21V 1/00

(52) U.S. Cl. CPC F21V 1/00
USPC 362/311.13

(57) ABSTRACT

The present invention provides a decoration for candle, which generally includes a decoration body and a light-emitting device. The decoration body is of a light-transmitting three-dimensional configuration and has a side that is recessed to form a compartment. The light-emitting device is mounted in the compartment. A positioning section is mounted, in a radial direction, to the light-emitting device and is tapering from inside to outside end. As such, the decoration body is pinned to a candle by the positioning section to provide the candle with rich and beautiful visual effect when the light-emitting device emits light.

### TECHNICAL FIELD OF THE INVENTION

The present invention generally relates to a decoration for candle, and more particularly to a decoration that enhances visual effect of candle.

### DESCRIPTION OF THE PRIOR ART

The raise of living standard allows modem people to pay more attention to the quality of leisure life. Beside selection of household articles, creation of atmosphere is also an important part. The most commonly used product for creating domestic atmosphere is perfuming candle, which improves the freshness and aromatic smell of the ambient air and also contributes to the beautification of surroundings.

However, most of the candles that are currently available are improved by just modifying the shapes thereof or wrapping a film carrying patterns around the candles. Although the configuration or shape of a candle may be made unique, yet it is just one shape or configuration and it generally does not allow a user to change as desired.

In view of this, the present invention aims to provide a decoration for candle that allows the coexistence of enhanced fun and beautiful visual effect in a candle.

### SUMMARY OF THE INVENTION

Thus, the present invention provides a decoration for candle, which comprises:

a decoration body, which is of a light-transmitting three-dimensional configuration, the decoration body having a side that is recessed to form a compartment; and

a light-emitting device, which is mounted in the compartment of the decoration body, the light-emitting device comprising a light-emitting element, a switch, and a positioning section that is arranged in a radial direction and is tapering from inside to outside end, the light-emitting element being controlled by the switch for selectively lighting on/off.

As such, the decoration body can be pinned to a candle by the positioning section to provide rich fun to the candle and can also provide the candle with beautiful visual effect when irradiated by light emitting from the light-emitting element.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view showing the present invention.

FIG. 2 is an exploded view of the present invention.

FIG. 3 is a perspective view showing an embodiment of a positioning section of the present invention.

FIG. 4 is a cross-sectional view of the present invention.

FIG. 5 is an exploded view showing the use of the present invention.

FIG. 6 is an assembled view illustrating the use of the present invention.

FIG. 7 is a cross-sectional view showing the use of the present invention.

FIG. 8 is a top plan view showing the use of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

FIG. 1 is a perspective view showing a decoration for candle according to a preferred embodiment of the present invention in an assembled formed. FIG. 2 is an exploded view of the decoration. As shown in FIGS. 1 and 2, the present invention provides a decoration 1, which comprises a decoration body 2 and a light-emitting device 3.

The decoration body 2 is of a light-transmitting three-dimensional configuration, which can be a configuration related to geometrical shapes, animals, plants or festivals and celebrations. The decoration body 2 has a side that is inwardly recessed to form a compartment 21 having an opening.

The light-emitting device 3 is mounted in the compartment 21 of the decoration body 2 and comprises a light-emitting element 31, a switch 32, a circuit, and a positioning section 33 that is arranged in a radial direction and is tapering from the inside end to the outside end. The light-emitting element 31 can be a light-emitting diode (LED) that is electrically connected to the circuit and is controlled by the switch 32 for selectively lighting on/off with electrical power being supplied from for example a battery. The supply of electrical power is generally known and constitutes no novel part of the present invention so that further details are omitted. In the instant embodiment, a lid 34 is further included for closure of the opening of the compartment 21. The positioning section 33 extends in the radial direction from the lid 34 or the decoration body 2. In the instant embodiment, the positioning section 33 is of a conic shape or a pyramid shape or, as shown in FIG. 3, may alternatively be a structure comprising a plurality of spaced ribs 35 that extends outward.

As shown in FIG. 4, which is a cross-sectional view of the decoration according to the present invention, the light-emitting element 31 is set at the side that is opposite to the positioning section 33 so that the light generated thereby is allowed to transmit through the decoration body 2 to provide the decoration body 2 with a beautiful visual effect.

Referring to FIGS. 5-7, which are respectively an exploded view, an assembled view, and a cross-sectional view of an example of use of the decoration according to the present invention, the tapering configuration of the positioning section 33 provides a sharp tip that can pierce into a candle 4 to be positioned thereon so as to make the candle 4 exhibit rich fun. The outward extending ribs 35 of the positioning section 33 may provide multiple faces frictional engagement with the candle 4 so as to more securely position the decoration body 2 on the candle 4, eliminating the potential risk of swaying thereof.

Further, the side of the decoration body 2 in which the compartment 21 is formed can be flat or curved (see FIG. 8). When the candle 4 is of a cylindrical form, the side that is made curved provides tight engagement with the candle 4 to enhance the effect of positioning.

With the above structure and operation described above, the decoration 1 provided by the present invention for candle can pin the decoration body 2 to the candle 4 to improve the fun of the candle 4 and also provide a second effect of beautiful lighting for visual perception.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A decoration for candle, comprising:
a decoration body, which is of a light-transmitting three-dimensional configuration, the decoration body having a side that is recessed to form a compartment; and
a light-emitting device, which is mounted in the compartment of the decoration body, the light-emitting device comprising a light-emitting element, a switch, and a positioning section that is arranged in a radial direction and is tapering from inside to outside end, the light-emitting element being controlled by the switch for selectively lighting on/off.

2. The decoration for candle according to claim 1, wherein the positioning section is of a conic shape.

3. The decoration for candle according to claim 1, wherein the positioning section comprises at least one rib that extends outwards.

4. The decoration for candle according to claim 1, wherein the side of the decoration body that forms the compartment is a flat surface.

5. The decoration for candle according to claim 1, wherein the side of the decoration body that forms the compartment is a cured surface.
